(19) United States
(12) Patent Application Publication
(10) Pub. No.: US 2009/0022629 A1
(43) Pub. Date: Jan. 22, 2009

(54) SOLID-STATE UREA BIOSENSOR

(75) Inventors: Shen-Kan Hsiung, Tao-Yuan (TW); Jung-Chuan Chou, Tao-Yuan (TW); Tai-Ping Sun, Tao-Yuan (TW); Nien-Hsuan Chou, Tao-Yuan (TW); Chung-We Pan, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/778,674

(22) Filed: Jul. 17, 2007

(51) Int. Cl. G01N 27/333; B01J 19/00

(52) U.S. Cl. 422/82.03; 422/68.1

(57) ABSTRACT

A solid-state urea biosensor may comprise a substrate, an electrically conductive layer, a PH sensing film, an ammonium ion selecting film and a ferment film. The electrically conductive layer covers the substrate. The PH sensing film has a PH value measuring zone, partially covering the electrically conductive layer, for measuring the PH value of a solution to be tested. The ammonium ion selecting film has an ammonium ion measuring zone for measuring the ammonium ion concentration. The ammonium ion selecting film partially covers the PH sensing film and exposes the PH value measuring zone. The ferment film is used for measuring the urea concentration in the solution, wherein the ferment film partially covers the ammonium ion selecting film and exposes the ammonium ion measuring zone.

### BACKGROUND OF THE INVENTION

1. Field of the Invention

The present invention generally relates to solid-state urea biosensors, and more particularly, a solid-state urea biosensor using an ammonium ion selecting film/Tin dioxide as an ion sensing film.

2. Description of the Prior Art

The human body needs to absorb food in order to maintain life. Food will produce wastes as a result of metabolism of the body. Kidney, besides maintaining levels of electrolytes and water in the body, also plays the role of eliminating waste products from metabolism. The basic unit of a kidney is a nephron. There are about 2 million nephrons in the kidneys in both sides the body, but only 1/10 of the nephrons are at work everyday, that is, 200,000 nephrons. The remaining are at rest. One can still manage without a kidney through donation; a single kidney suffices to carry out the normal function of the kidneys. However, when kidneys are damaged to a certain degree where they can no longer perform their vital tasks, it is referred to as kidney failure. A kidney function test is used to evaluate how well the kidneys are functioning. Since the function of the kidney is to eliminate waste, we are able to determine if the kidneys are performing adequately by evaluating how much waste is still inside the body.

Clinically, there are two types of waste substances that can be used as the basis of assessment. They are urea and creatinine in the blood. Urea is a waste product created by protein metabolism in the liver. After urea is created in the liver, it is taken to the kidney via bloodstream. After filtration by glomerulus, a small part of the urea is absorbed from the renal tubule back into the bloodstream while most of the urea is excreted via urine. Therefore, the level of urea in the blood is dependent on the production of urea and the excretion of the kidneys.

There are two reasons for a rising urea level. First is excretion dysfunction. For example, when there is a fixed amount of protein intake and no other reasons for increase in production, the urea level in the blood is total dependent on the excretion of kidneys (kidneys' functionality). Thus, the level of decline in kidney function can be determined from the level of urea in the blood.

The second reason is the increase in production. For example, damage of histone. The sources of proteins in the body may come from food intake as well as impaired body tissues, such as when the body experiences a burn, a surgery, a fever, thyroid hyperfunction, a malignant tumor, diabetic ketosis acid poisoning, or hunger. When the amount of proteins being metabolized increases, the level of urea in the blood rises accordingly.

In view of the importance of urea level testing, the inventors of this application diligently researched and successfully invented the novel solid-state biosensor of the present invention.

### SUMMARY OF THE INVENTION

An objective of the present invention is to provide a solid-state urea biosensor, which comprises a substrate, an electrically conductive layer, a PH sensing film, an ammonium ion selecting film and a ferment film. The electrically conductive layer covers the substrate. The PH sensing film has a PH value measuring zone, partially covering the electrically conductive layer, for measuring the PH value of a solution to be tested. The ammonium ion selecting film has an ammonium ion measuring zone for measuring the ammonium ion concentration. The ammonium ion selecting film partially covers the PH sensing film while exposing the PH value measuring zone. The ferment film is used for measuring the urea concentration in the solution, wherein the ferment film partially covers the ammonium ion selecting film while exposing the ammonium ion measuring zone.

The solid-state urea biosensor has a greater measuring accuracy than those of the prior art.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a flowchart illustrating a method for manufacturing a solid-state urea biosensor and a method for acquiring signals therefrom according to a second preferred embodiment of the present invention;

FIG. 2 is a plain view of the solid-state urea biosensor according to the second preferred embodiment of the present invention;

FIG. 3 is a cross-sectional view of the solid-state urea biosensor according to the second preferred embodiment of the present invention;

FIG. 4 is a diagram showing measuring of the solid-state urea biosensor according to the second preferred embodiment of the present invention;

FIG. 5 is a read-out circuit diagram of a solid-state urea biosensor acquisition system according to the second preferred embodiment of the present invention;

FIG. 6 is a diagram depicting a front panel of the solid-state urea biosensor acquisition system;

FIG. 7 is a diagram depicting a computational program of the solid-state urea biosensor acquisition system;

FIG. 8 is plot showing output signals of the solid-state urea biosensor;

FIG. 9 is a plot showing sensing characteristics of the solid-state urea biosensor analyzed using a linear regression technique;

FIG. 10 is a plot showing sensing characteristics of the solid-state urea biosensor analyzed using a sigmoid regression technique;

FIG. 11 is a flowchart illustrating a method for manufacturing a solid-state urea biosensor and a method for acquiring signals therefrom according to a first preferred embodiment of the present invention;

FIG. 12 is a plain view of the solid-state urea biosensor according to the first preferred embodiment of the present invention;

FIG. 13 is a cross-sectional view of the solid-state urea biosensor according to the first preferred embodiment of the present invention;

FIG. 14 is a diagram showing measuring of the solid-state urea biosensor according to the first preferred embodiment of the present invention;

FIG. 15 is a read-out circuit diagram of a solid-state urea biosensor acquisition system according to the first preferred embodiment of the present invention;

FIG. 16 is a plot showing a result of analyzing the sensing characteristics of the solid-state urea biosensor using sigmoid regression according to the first preferred embodiment of the present invention; and

FIG. 17 is a plot showing a result of analyzing electrode characteristics of a PH sensing film using linear regression according to the first preferred embodiment of the present invention.

### DETAILED DESCRIPTION OF THE PREFERRED EMBODIMENTS

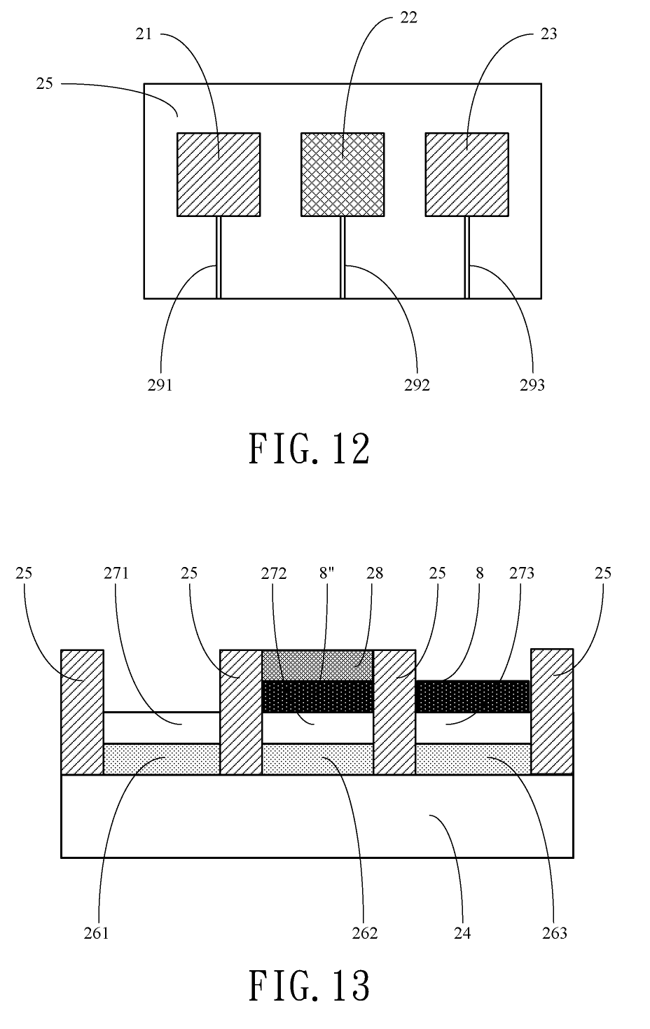

FIG. 13 is a cross-sectional schematic diagram illustrating a solid-state biosensor according to a first embodiment of the present invention. Referring to FIGS. 12 and 13 together, the solid-state biosensor 2 of the present invention may comprise a substrate 24, an electrically conductive layer, a PH sensing film, an ammonium ion selecting film and a ferment film. The substrate can be an insulating glass substrate. The substrate 24 can also be made of non-insulating substrate, such as indium tin oxide glass or tin dioxide glass.

An epoxy resin is disposed above the substrate 24 as an electrically insulating layer 25 and divides the substrate 24 into three sensing zones, such that these zones are electrically insulated from each other. Electrically conductive layers (denoted by 261, 262 and 263) are disposed on top of the substrate 24 in each of the three sensing zones, respectively. The substrate 24 is covered by the electrically conductive layers made of indium tin oxide as buffering layers. The electrically conductive layers 261, 262 and 263 can also be made of aluminum.

A tin dioxide film is sputtered onto the electrically conductive layers 261, 262 and 263 as a PH sensing film (denoted by 271, 272 and 273). The PH sensing films 271, 272 and 273 have a PH value measuring zone 271 acting as a dummy reference electrode 23, partially covering the electrically conductive layers 261, 262 and 263 for measuring the PH value of a solution to be tested.

An ammonium ion selecting film (denoted by 8 and 8″) is fixed on the PH sensing films 272 and 273. The ammonium ion selecting films 8 and 8 ″ have an ammonium ion measuring zone 8 as a comparison electrode 21 for measuring the ammonium ion concentration of the solution. The ammonium ion selecting films 8 and 8″ partially cover the PH sensing film 272 and 273 while exposing the PH value measuring zone 271.

A ferment film 28 is fixed on the ammonium ion selecting film 8″ acting as a ferment working electrode 22. This ferment film 28 is used to measure the urea concentration of the solution. The ferment film 28 partially covers the ammonium ion selecting film 8″ while exposing the ammonium ion measuring zone 8.

The ferment may be uremia. The ferment film 28 may immobilize the ferment via physical entrapment or covalent attachment. Physical entrapment may immobilize ferment by polymers that may be, for example, poly (vinyl alcohol) bearing styrylpyridinium groups (PVA-SbQ). Covalent attachment employs chemical substances to immobilize ferment. The chemical substance can, for example, be 3-glycidoxypropyltrimethoxysilane (GPTS). The other two sensing zones are the comparison electrode 21 and the dummy reference electrode 23, respectively. Each of the sensing zones is connected with a wire 291, 292 and 293, respectively, for transmitting sensing signal from each of the sensing zones.

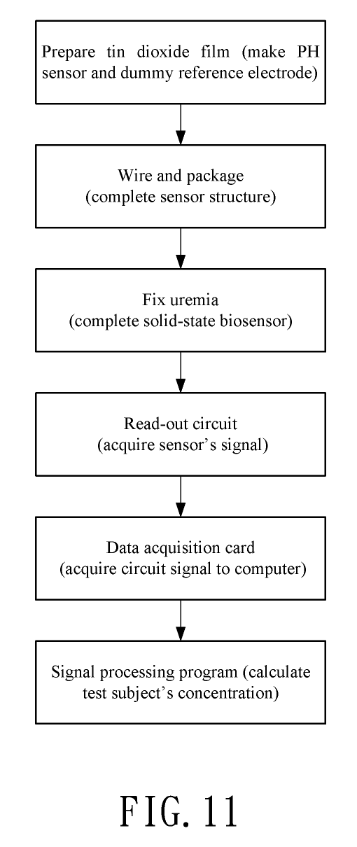

The method for manufacturing the solid-state urea biosensor provided in the first preferred embodiment of the present invention and a data acquisition system for acquiring signals from the biosensor are described in FIG. 11. A tin dioxide film is first prepared 101 to obtain a PH sensor and a dummy reference electrode. Then, wiring and packaging are performed 102 to complete the sensor's structure. Thereafter, an ion selecting film is fixed 103 and uremia is fixed 104 onto the tin dioxide film to realize a urea biosensor. By this stage, the manufacturing of the solid-state urea biosensor is completed. After that, a read-out circuit is made 105 to acquire biosensor's signals, and then a data acquisition card is used to acquire circuit signals to the computer 106. Finally, signals of the test subject are displayed 107, thereby completing the method for manufacturing a solid-state urea biosensor and a data acquisition system.

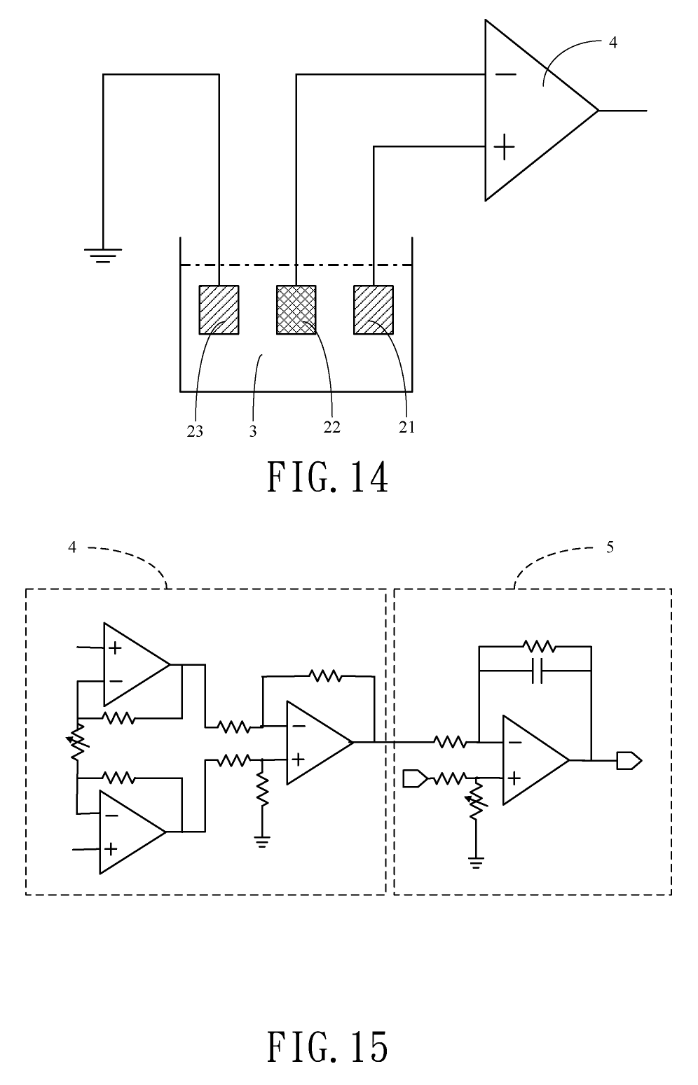

A circuit for measuring the solid-state urea biosensor provided by the present invention is shown in FIG. 14. The sensing elements of the solid-state urea biosensor 2 are placed into the solution to be tested 3, wherein the dummy reference electrode 23 is connected to ground to define a reference potential of the solution 3 and provide a circuit-level voltage, thus improving signal stability of the sensing elements. The comparison electrode 21 is connected to the positive input terminal of an instrumentation amplifier 4 to provide a differential signal. The differential signal defines a comparison potential for the solid-state urea biosensor 2. The ferment working electrode 22 is connected to the negative input terminal of the amplifier for providing a main sensing signal. The sensing signal defines a working potential for the solid-state urea biosensor 2. More specifically, the potential acquired by the instrumentation amplifier 4 is the potential of the comparison electrode 21 minus that of the ferment working electrode 22. Furthermore, since the ferment working electrode 22 is fixed on the ion sensing film 8″ made of the ammonium ion selecting film, the PH sensing film 272 and the comparison electrode 21 (i.e. the ammonium ion selecting film 8) have the same potential during measurement, the output potential difference of which is zero. Thus, the output potential will be the sensing potential of the ferment working electrode 22. As a result, the solid-state urea biosensor 2 of the present invention can effectively eliminate the effects of temperature-drift and time-drift, enhancing stability and accuracy of the sensing elements.

The read-out circuit structure of the acquisition system for the solid-state urea biosensor is shown in FIG. 15. The read-out circuit is consisted of the instrumentation amplifier 4 and a low-pass filter 5. The instrumentation amplifier 4 acquiring the differential signal of the sensing elements to the circuit includes an amplifier and a resistor. A variable resistor can be used to vary the gain of the circuit in order to effectively acquire and amplify the differential signal, thereby increasing resolution of the signal. It is advantageous in terms of high input impedance, infinitely large common-mode rejection ratio (CMRR), high gain and low noise. Thus, the differential signal of the solid-state urea biosensor can be effectively acquired, and interference of low-frequency noise can be reduced. The signal with increased resolution is then passed to the low-pass filter 5 including an amplifier, a resistor, and a capacitor. It can be used for eliminating high-frequency noise and increasing signal strength of the sensing elements.

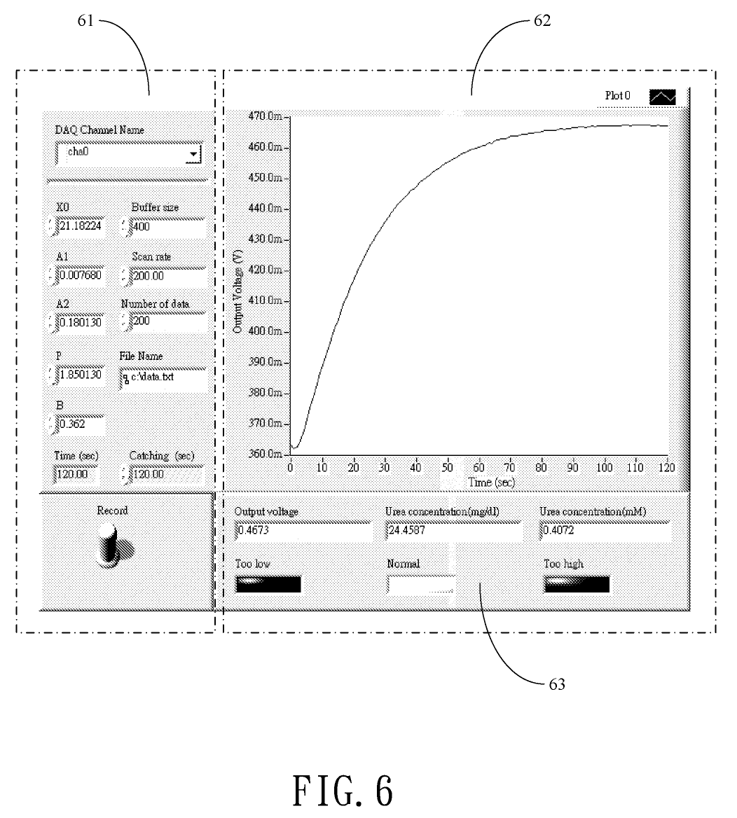

The signal of the sensing elements, after acquired by the read-out circuit, is transferred to a computer terminal via a data acquisition card. The data acquisition card can be a GPIB card or a DAQ card, which converts the analog signal of the circuit into digital signal and transfers it to the computer terminal. The concentration of the test subject is then calculated by a signal analysis program of the present invention, which analyzes, calculates and stores the digital signal and can for example be LabVIEW or HP VEE. A display panel of the signal analysis program includes a computation parameter setting panel 61, an output potential display panel 62 and a tested solution's concentration display panel 63, as shown in FIG. 6.

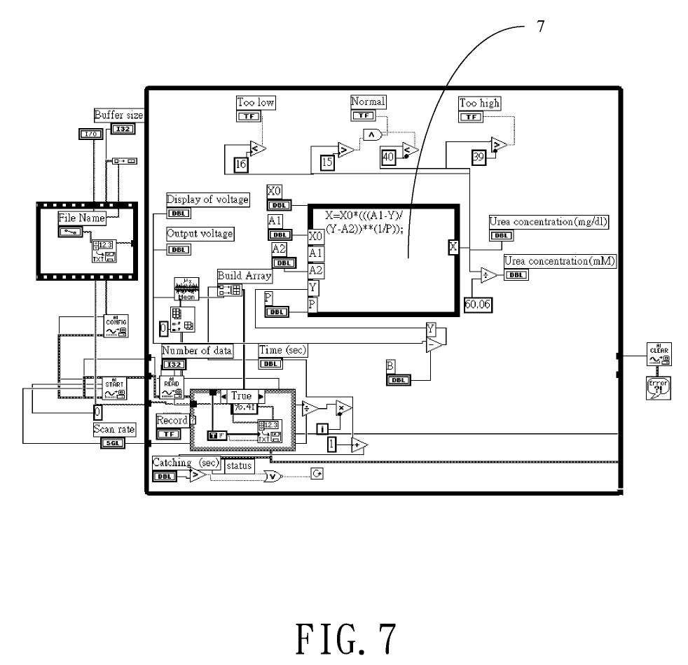

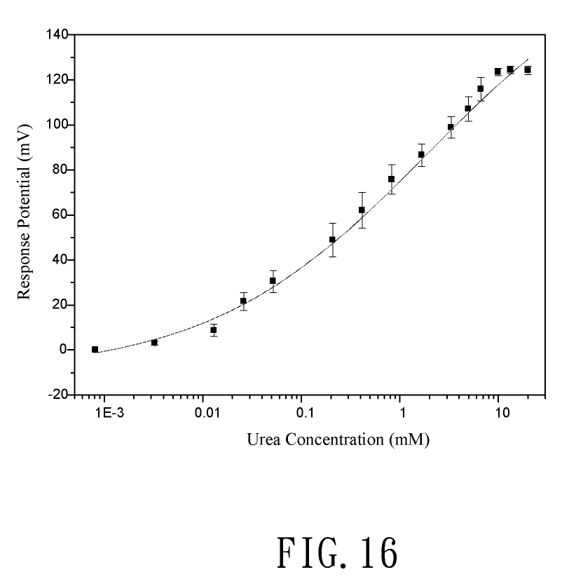

The first preferred embodiment of the present invention employs a sigmoid regression technique to analyze the characteristics of the solid-state urea biosensor. The analysis result is shown in FIG. 16. The concentration of the area of the urea biosensor being calculated is between about 10⁻³˜10 mM. The calculated value closely follows the sensed data. There is a minor error between the average signal of the sensing elements and linear regression values. Thus, sigmoid analysis technique can be used not only to calculate concentration of the solution, but also to increase accuracy of the calculated values. Therefore, the computational function used by the signal analysis program of the present invention is a sigmoid regression program (shown in FIG. 7) that uses sigmoid analysis technique to calculate the concentration of the solution so as to increase the accuracy and computational range of data.

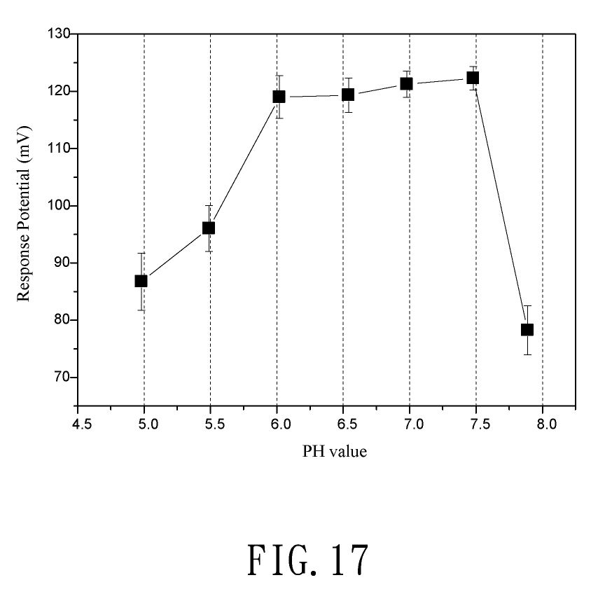

The first preferred embodiment of the present invention uses a linear regression technique to analyze the electrode characteristics of the PH sensing film. The analysis result is shown in FIG. 17. When the PH value is 6.0˜8.5, the response signal values are not proportional to the PH values. Therefore, the urea concentration cannot be properly detected solely by the PH sensing film electrode. A possible reason is that the existence of other ions such as hydrogen and potassium ions in the solution affects the measuring accuracy of the PH sensing film electrode.

It is found that urea in a solution may partially release hydrogen ions as well as ammonium ions. Ammonium ions are different in terms of their properties from hydrogen or potassium ions, the prior being less sensitive to impurity ions. Thus, an ammonium ion selecting film electrode is more suitable for providing the comparison electrode than the PH sensing film electrode, thereby increasing measuring accuracy of the urea biosensor of the present invention. In summary, the solid-state urea biosensor according to the first preferred embodiment of the present invention has greater measuring accuracy that those of the prior art.

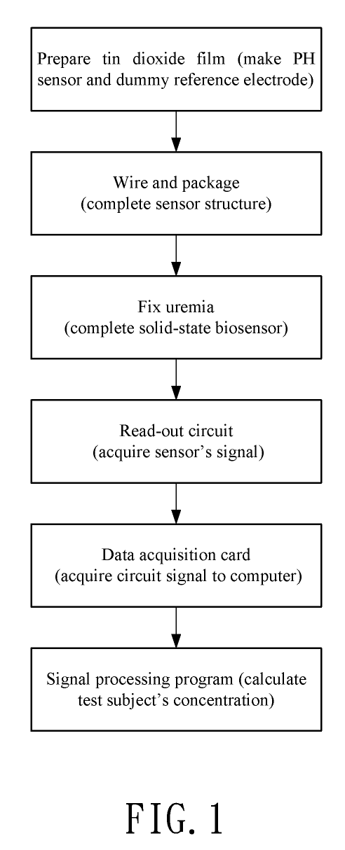

The method for manufacturing the solid-state urea biosensor according to a second preferred embodiment of the present invention and a data acquisition system for acquiring signals from the biosensor are described in FIG. 1. A tin dioxide film is first prepared 101 to obtain a PH sensor and a dummy reference electrode. Then, wiring and packaging are performed 102 to complete the sensor's structure. Thereafter, an ion selecting film is fixed 103 and uremia is fixed 104 onto the tin dioxide film to realize a urea biosensor. By this stage, the manufacturing of the solid-state urea biosensor is completed. After that, a read-out circuit is made 105 to acquire biosensor's signals, and then a data acquisition card is used to acquire circuit signals to the computer 106. Finally, signals of the test subject are displayed 107, thereby completing the method for manufacturing a solid-state urea biosensor and a data acquisition system.

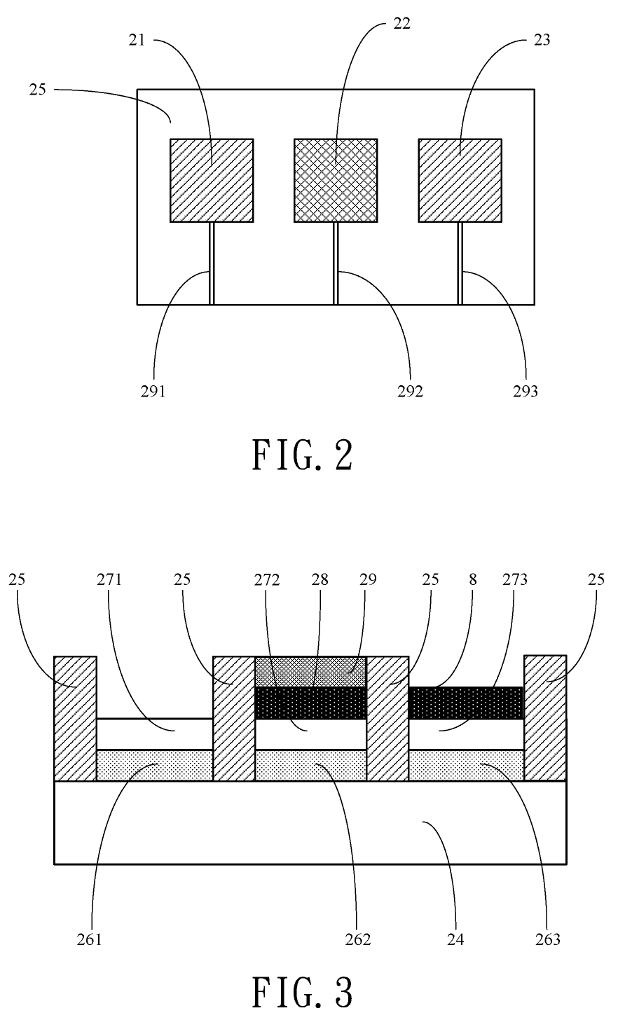

A plain view and a cross-sectional view of the solid-state urea biosensor 2 of the present invention are shown in FIGS. 2 and 3, respectively. An insulating glass is used as a substrate 24. Non-insulating materials can also be used as the substrate 24, such as indium tin oxide glass or tin dioxide glass. An epoxy resin is disposed above the substrate 24 as an electrically insulating layer 25, which divides the substrate 24 into three sensing zones, such that these three zones are electrically insulated from each other. Electrically conductive layers (denoted by 261, 262 and 263) are disposed on top of the substrate 24 in each of the three sensing zones, respectively. The electrically conductive layers 261, 262 and 263 are made of indium tin oxide as buffering layers. The electrically conductive layers 261, 262 and 263 can also be made of aluminum. A tin dioxide film is sputtered onto the electrically conductive layers 261, 262 and 263 as PH sensing films 271, 272 and 273, respectively. On top of the PH sensing film 272, an ion selecting film 28 and a ferment film 29 are fixed to form a ferment working electrode 22. The ferment may be uremia. The ferment film 29 may immobilize the ferment via physical entrapment or covalent attachment. Physical entrapment may immobilize ferment by polymers that may be, for example, poly (vinyl alcohol) bearing styrylpyridinium groups (PVA-SbQ). Covalent attachment employs chemical substances to immobilize ferment. The chemical substance can, for example, be 3-glycidoxypropyltrimethoxysilane (GPTS). The other two sensing zones are the comparison electrode 21 and the dummy reference electrode 23, respectively. Each of the sensing zones is connected with a wire 291, 292 and 293, respectively, for transmitting sensing signal from each of the sensing zones.

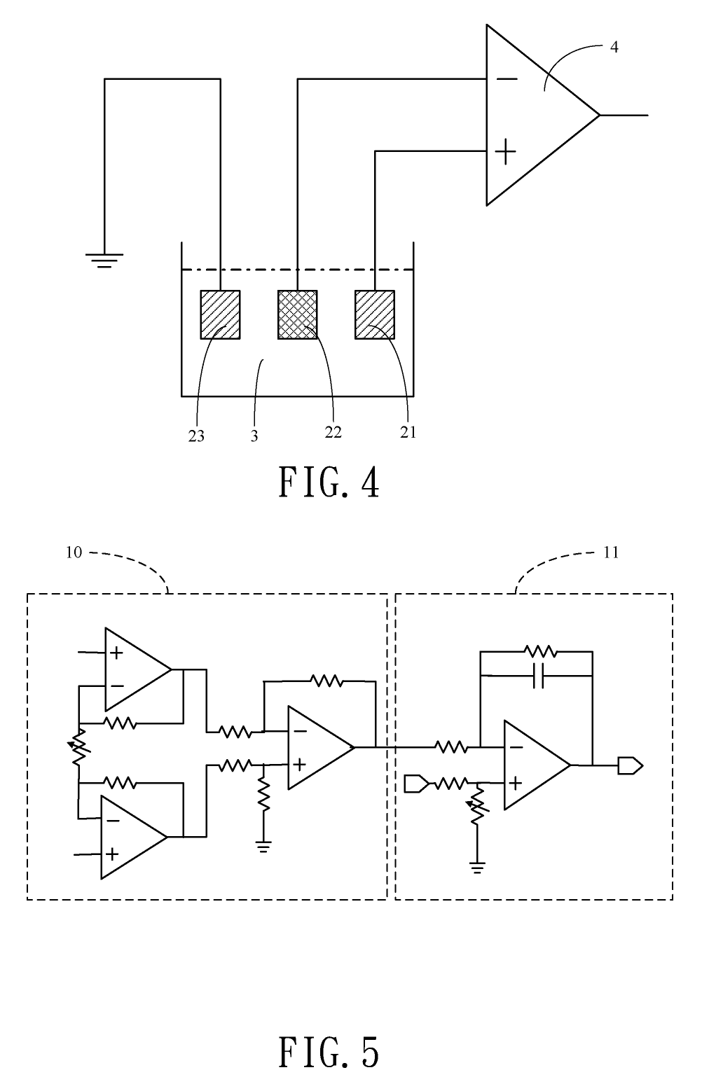

A circuit for measuring the solid-state urea biosensor 2 provided by the present invention is shown in FIG. 4. The sensing elements of the solid-state urea biosensor 2 are placed into the solution to be tested 3, wherein the dummy reference electrode 23 is connected to ground to define a reference potential for the solution 3 and provide a circuit-level voltage, thus improving signal stability of the sensing elements. The comparison electrode 21 is connected to the positive input terminal of an instrumentation amplifier 4 to provide a differential signal. The differential signal defines a comparison potential for the solid-state urea biosensor 2. The ferment working electrode 22 is connected to the negative input terminal of the amplifier for providing a main sensing signal. This sensing signal defines a working potential for the solid-state urea biosensor 2. More specifically, the potential acquired by the instrumentation amplifier 4 is the potential of the comparison electrode 21 minus that of the ferment working electrode 22. Furthermore, since the ferment working electrode 22 is fixed on the PH sensing film 272 made of a tin dioxide film, the PH sensing film 272 and the comparison electrode 21 (i.e. made of the tin dioxide film) have the same potential during measurement; the output potential difference of which is zero. Thus, the output potential will be the sensing potential of the ferment working electrode 22. As a result, the solid-state urea biosensor 2 of the present invention can effectively eliminate the effects of temperature-drift and time-drift, enhancing stability and accuracy of the sensing elements.

The read-out circuit structure of the acquisition system for the solid-state urea biosensor of the present invention is shown in FIG. 5. The read-out circuit is consisted of the instrumentation amplifier 4 and a low-pass filter 5. The instrumentation amplifier 4 acquiring the differential signal of the sensing elements to the circuit includes an amplifier and a resistor. A variable resistor can be used to vary the gain of the circuit in order to effectively acquire and amplify the differential signal, thereby increasing resolution of the signal. It is advantageous in terms of high input impedance, infinitely large common-mode rejection ratio (CMRR), high gain and low noise. Thus, the differential signal of the solid-state urea biosensor can be effectively acquired, and interference of low-frequency noise can be reduced. The signal with increased resolution is then passed to the low-pass filter 5 including an amplifier, a resistor, and a capacitor. It can be used for eliminating high-frequency noise and increasing signal strength of the sensing elements.

The signal of the sensing elements, after acquired by the read-out circuit, is transferred to a computer terminal via a data acquisition card. The data acquisition card can be a GPIB card or a DAQ card, which converts the analog signal of the circuit into digital signal and transfers it to the computer terminal. The concentration of the test subject is then calculated by a signal analysis program of the present invention, which analyzes, calculates and stores the digital signal and can for example be LabVIEW or HP VEE. A display panel of the signal analysis program includes a computation parameter setting panel 61, an output potential display panel 62 and a tested solution's concentration display panel 63, as shown in FIG. 6.

As shown in FIG. 6, the computation parameter setting panel 61 is used for setting a data acquisition channel, computation parameters, file name and location of the data, signal acquisition time and period. Thus, if the fundamental characteristics of the sensing elements change, they can be modified through the computation parameter setting panel 61, providing more operational flexibility. The output potential display panel 62 is used to display the variations in the sensed potential of the sensor. The output potential display panel 62 allows modifications of the unit and interval of the output signal, modification of the interval of acquisition time in order to display response potential in real-time and analysis of the response potential to see if the variation is normal. The output potential shown is the actual output voltage of the sensing elements. The tested solution's concentration display panel 63 is used to display the output potential, the concentration of the tested subject (i.e. urea concentration) and indicators. Concentrations of the tested subject above, below or the same with the normal value can be shown on the panel 63. Two kinds of units for urea concentration are available (mg/dl and M) to avoid trouble in unit conversion. The indicators include a “Too high” indicator, a “Normal” indicator and a “Too low” indicator to indicate the relativity of the test subject and the normal value of the human body. When a single indicator is on, it indicates that the measured concentration is within that particular range indicated by the turned-on indicator (e.g. in the high, normal or low range). When two indicators are on, it indicates that the measured concentration is between the ranges indicated by the turned-on indicator (e.g. between the high and normal range or the normal and low range). The “Too high” indicator indicates that the urea concentration is above 39 mg/dl. The “Normal” indicator indicates that the urea concentration is between 15˜40 mg/dl. The “Too low” indicator indicates that the urea concentration is below 16 mg/dl. However, these ranges are given for illustration purpose only. They are not intended to limit the present invention in any way.

FIG. 7 shows a signal analysis program of the present invention. The computational function 7 is used to calculate the urea concentration. The computation formula used herein is sigmoid regression suitable for analyzing biosensor's signal, thus increasing accuracy of signal analysis. The data are stored in the computer for long-term status tracking and analysis. The data storage can be a hard disk, a flash drive, a portable hard disk, a network hard disk etc.

### EXAMPLE 1

### Signal Acquisition and Analysis of Solid-State Urea Biosensor

This example uses the solid-state urea biosensor 2 of the present invention (FIG. 2). The method of measurement is shown in FIG. 4. The sensing elements of the solid-state urea biosensor 2 are placed into the solution to be tested 3. The dummy reference electrode 23 is connected to ground. The comparison electrode 21 is connected to the positive input terminal of the instrumentation amplifier 4. The ferment working electrode 22 is connected to the negative input terminal of the instrumentation amplifier 4, such that a differential signal of the solid-state urea biosensor 2 is inputted into the instrumentation amplifier 4. The circuit gain is set to 1. The low-pass filter 5 (as shown in FIG. 5) is then used to eliminate circuit noise. The circuit signals is transferred by the data acquisition card to the computer terminal and displayed on the output potential display panel 62 (as shown in FIG. 6). The panel 62 may monitor the output potential of the solid-state urea biosensor 2 to see if it is functioning properly define basic potential value. The computation parameter display panel 61 is used for inputting parameters for processing by the computational function 7 of FIG. 7 to obtain the concentration of the solution 3. The calculated result is shown in the tested solution's concentration display panel 63, in which the measured concentration is compared with the normal value of the human body and this relativity is shown on the display panel 63 as too high, normal or too low, informing users of the concentration status of the tested solution 3. The results are stored in a hard disk of the computer with a file name “data.txt” to allow long-term status tracking and analysis.

### EXAMPLE 2

### Variation in Output Potential of Solid-State Urea Biosensor

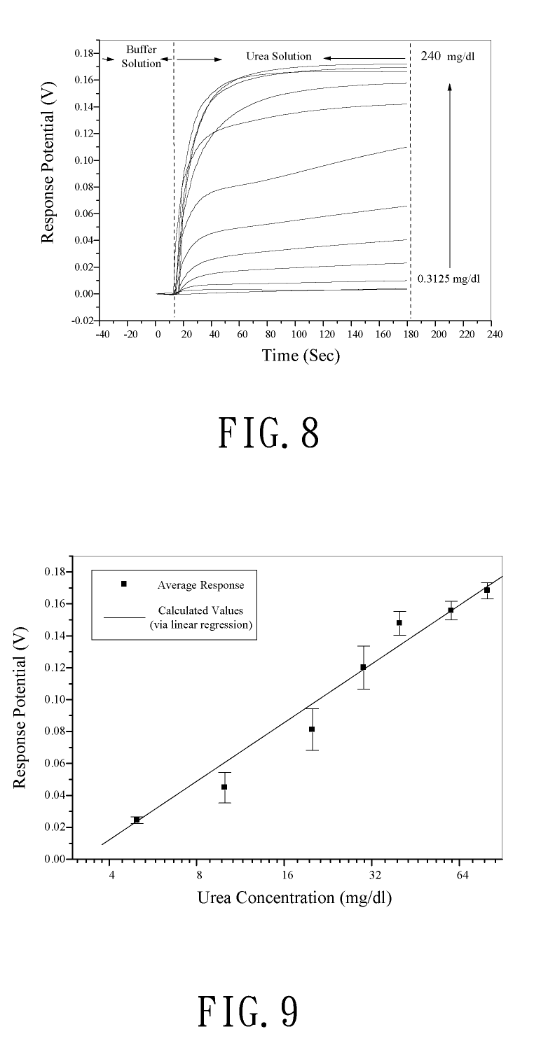

The solid-state urea biosensor 2 of the present invention (FIG. 2) is placed in a different solution 3 (as shown in FIG. 4). The method of measurement is the same as in example 1. The dummy reference electrode 23 is connected to ground. The comparison electrode 21 is connected to the positive input terminal of the instrumentation amplifier 4. The ferment working electrode 22 is connected to the negative input terminal of the instrumentation amplifier 4, such that a differential signal of the solid-state urea biosensor 2 is inputted into the instrumentation amplifier 4. The circuit gain is set to 1. The low-pass filter 5 (as shown in FIG. 5) is then used to eliminate circuit noise. The circuit signals is transferred by the data acquisition card to the computer terminal and stored as “data.txt” in a computer hard disk. Finally, the output potentials of the different solutions 3 varying with respect to time are shown in FIG. 8. It can be known from FIG. 8 that the response time of the solid-state urea biosensor 2 of the present invention varies with the concentration of the solutions 3 from about 60 to 120 seconds. The range for measuring urea concentration is from 0.3125 to 240 mg/dl. This range exceeds the normal range (15 to 40 mg/dl) of the human body. The highest output potential is about 175 mV. The output voltage increases with the increase in urea concentration. The output signal is stable. Therefore, the solid-state urea biosensor 2 of the present invention has good sensitivity. The data extraction system can extract signal and store data for subsequent analysis.

### EXAMPLE 3

### Analysis of Solid-State Urea Biosensor Using Linear Regression Technique

This example uses a linear regression technique to analyze the characteristics of the solid-state urea biosensor. The result of analysis is shown in FIG. 9, wherein the concentration calculated for the solid-state urea biosensor is from 5 to 80 mg/dl, which exceeds the normal range (15 to 40 mg/dl) of the human body. However, at concentration 10 mg/dl ad 20 mg/dl, the linear regression values are significantly deviated from the average signal of the sensing elements. Thus, the linear regression technique can be used to analyze the characteristics of the solid-state urea biosensor, but with significant deviations.

### EXAMPLE 4

### Analysis of Solid-State Urea Biosensor Using Sigmoid Regression Technique

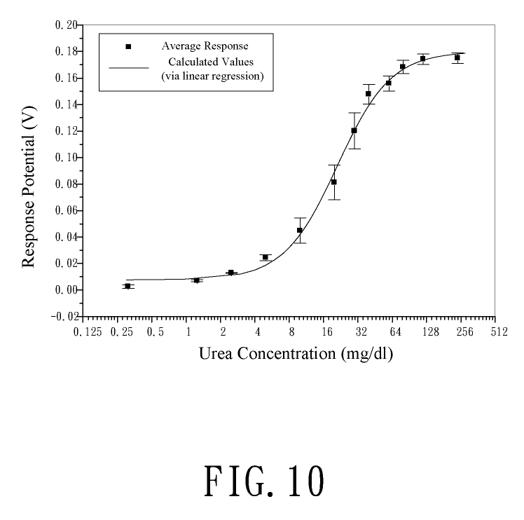

This example uses a sigmoid regression technique to analyze the characteristics of the solid-state urea biosensor. The result of analysis is shown in FIG. 10, wherein the concentration calculated for the solid-state urea biosensor is from 0.3125 to 240 mg/dl, which exceeds the normal range (15 to 40 mg/dl) of the human body. The calculated results more closely follow the actual measurements. Therefore, the computational function used by the signal analysis program of the present invention is a sigmoid regression program (shown in FIG. 7) that uses sigmoid analysis technique to calculate the concentration of the solution with greater accuracy and larger computational range.

The solid-state urea biosensor provided in the second preferred embodiment of the present invention and the data acquisition method thereof, when compared to those of the prior art, have the following advantages:

1. The solid-state urea biosensor of the present invention uses electrically conductive material as the sensing material and uses a single material for making the dummy reference electrode and the comparison electrode, providing a stable reference potential to the circuit and the solution to be tested. Thus, the present invention uses only one material to make two electrodes, reducing manufacturing steps and cost, making large production of disposable biosensing elements possible.

2. The solid-state urea biosensor of the present invention uses only one material to make the dummy reference electrode and the comparison electrode, eliminating temperature-drift and time-drift effects and enhancing stability and accuracy of the sensing elements.

3. The method for acquiring data from the solid-state urea biosensor of the present invention employs a data acquisition system that can be combined with a differential-pair biosensor. This allows effective acquisition of sensing elements' signals. A sigmoid regression technique is also employed to calculate the concentration of the test subject. Compared to a traditional linear analysis, this sigmoid analysis technique adopted by the present invention has higher accuracy and resolution and larger calculation range.

4. The data acquisition system has an interface with panels that are easy to use and enables real-time adjustment, real-time display, real-time calculation and real-time analysis.

5. The solid-state urea biosensor of the present invention and the data acquisition method thereof can be applied to home medical testing by providing real-time analysis through user-friendly and flexible real-time measuring and analysis software. In addition, the test results can be transferred to a medical facility via a network to establish a complete patient record.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled. For example, modifications or variations in the substrate of the solid-state urea biosensor and the materials used for the electrodes are all within the scope of the present invention.

1. A solid-state urea biosensor, comprising:
a substrate;
an electrically conductive layer covering the substrate;
a PH sensing film having a PH value measuring zone partially covering the electrically conductive layer for measuring the PH value of a solution to be tested;
an ammonium ion selecting film having an ammonium ion measuring zone for measuring ammonium ion concentration of the solution, wherein the ammonium ion selecting film partially covers the PH sensing film while exposing the PH value measuring zone; and
a ferment film for measuring urea concentration of the solution, wherein the ferment film partially covers the ammonium ion selecting film while exposing the ammonium ion measuring zone.

2. A solid-state urea biosensor of claim 1, wherein the substrate is glass.

3. A solid-state urea biosensor of claim 1, wherein the PH sensing film is tin dioxide.

4. A solid-state urea biosensor of claim 1, wherein the electrically conductive layer is one of indium tin oxide and aluminum.

5. A solid-state urea biosensor, comprising:
a substrate;
an electrically conductive layer covering the substrate;
a PH sensing film having a dummy reference electrode partially covering the electrically conductive layer for measuring the PH value of a solution to be tested;
an ammonium ion selecting film having a comparison electrode for measuring ammonium ion concentration of the solution, wherein the ammonium ion selecting film partially covers the PH sensing film while exposing the dummy reference electrode; and
a ferment film having a ferment working electrode for measuring urea concentration of the solution, wherein the ferment film partially covers the ammonium ion selecting film while exposing the comparison electrode.

6. A solid-state urea biosensor of claim 5, wherein the substrate is made of one of insulating and non-insulating materials.

7. A solid-state urea biosensor of claim 6, wherein the non-insulating substrate is one of indium tin oxide glass and tin dioxide glass.

8. A solid-state urea biosensor of claim 5, wherein the electrically conductive layer is indium tin oxide.

9. A solid-state urea biosensor of claim 5, wherein the electrically conductive layer is aluminum.

10. A solid-state urea biosensor of claim 5, wherein the PH sensing film is tin dioxide.

11. A solid-state urea biosensor of claim 5, wherein the electrically conductive layer is one of indium tin oxide and aluminum.

12. A solid-state urea biosensor of claim 5, wherein the ferment film uses one of physical entrapment and covalent attachment to immobilize ferment.

13. A solid-state urea biosensor of claim 12, wherein the ferment is uremia.

14. A solid-state urea biosensor of claim 12, wherein the physical entrapment includes using polymer to immobilize the ferment.

15. A solid-state urea biosensor of claim 14, wherein the polymer includes poly (vinyl alcohol) bearing styrylpyridinium groups (PVA-SbQ).

16. A solid-state urea biosensor of claim 12, wherein the covalent attachment includes using a chemical substance to immobilize the ferment.

17. A solid-state urea biosensor of claim 16, wherein the chemical substance includes 3-glycidoxypropyltrimethoxysilane (GPTS)

18. A solid-state urea biosensor of claim 5, wherein the dummy reference electrode is a tin dioxide film for providing standard potential.

19. A solid-state urea biosensor of claim 5, wherein the ferment working electrode is a ferment film for providing response potential.

20. A solid-state urea biosensor of claim 5, wherein the comparison electrode is a tin dioxide film for providing a comparison potential for the ferment working electrode.
